(19) United States
(12) Patent Application Publication
(10) Pub. No.: US 2023/0208949 A1
(43) Pub. Date: Jun. 29, 2023

(54) SMARTPHONE HAVING EARPHONE STORAGE UNIT

(71) Applicants: Cheol Soo LIM, Seoul (KR); A Reum LIM, Daejeon (KR); Da Un LIM, Seoul (KR); Mi Rae LIM, Incheon (KR)

(72) Inventors: Cheol Soo LIM, Seoul (KR); A Reum LIM, Daejeon (KR); Da Un LIM, Seoul (KR); Mi Rae LIM, Incheon (KR)

(21) Appl. No.: 17/927,825

(22) PCT Filed: May 25, 2021
(86) PCT No.: PCT/KR2021/006481

§ 371 Date: Nov. 25, 2022

(30) Foreign Application Priority Data
May 26, 2020 (KR) 10-2020-0062802
May 26, 2020 (KR) 10-2020-0062811

(51) Int. Cl. H04M 1/02; H04R 1/10

(52) U.S. Cl. CPC H04M 1/0258; H04R 1/1025; H04R 2460/17

(57) ABSTRACT

The present invention relates to a smartphone having an earphone storage unit including: at least one an earphone storage unit formed in a cylindrical shape; and an earphone withdrawing unit for facilitating the withdrawal of an earphone stored in the earphone storage unit, wherein the earphone withdrawing unit includes: a cylinder; a shaft reciprocating in the cylinder; a knock member rotating in response to the shaft whenever the shaft is pressed; and an elastic member pushing the knock member outward in response to the knock member. The cylinder has guide grooves and guide protrusions formed inside the cylinder in a longitudinal direction. The shaft has a moving protrusion moving along the guide groove in response to the guide groove, and sawteeth rotating the knock member in response to the knock member, and is formed to reciprocate in the cylinder.

In order to withdraw the earphone stored in the earphone storage unit, when a user presses the earphone in an earphone insertion direction to a predetermined depth and releases the earphone, the shaft of the earphone withdrawing unit is pushed out so that the earphone is discharged.

### TECHNICAL FIELD

The present invention relates to a smartphone having an earphone storage unit, and more particularly, to a smartphone having an earphone storage unit, in which a Bluetooth earphone storage unit is provided so that a user can carry a Bluetooth earphone in a smartphone, thereby providing convenience in carrying and using the Bluetooth earphone.

### BACKGROUND ART

The present invention relates to a smartphone having an earphone storage part. With the development of communication technology, a 5G long term evolution (LTE) network was implemented, so people enjoy various contents by using smartphones through wireless communications. Accordingly, Bluetooth earphone users equipped with a Bluetooth function are gradually increasing compared with users using wired earphones each of which is connected to a voice output terminal of the smartphone.

Bluetooth refers to a short-range wireless technology standard connecting portable devices, such as smartphones and earphones, to each other to exchange information, and is mainly used when a low-power wireless connection is required at a short distance of about 10 m.

Recently, due to the development of technology, subminiature Bluetooth earphones have been released, and so, Bluetooth earphone users are increasing more. However, there is a disadvantage in that a user has to separately carry the Bluetooth earphone, a charger, and a smartphone.

Furthermore, there is an inconvenience in that the Bluetooth earphone must be recharged aside from recharging the smartphone.

In addition, in a case in which a battery of the Bluetooth earphone is exhausted while the Bluetooth earphone is used, the Bluetooth earphone cannot be used till being recharged through a Bluetooth earphone charger.

In order to solve the above disadvantages, Korean Patent Publication No. 10-2016-0128061 discloses a mobile integrated Bluetooth device. In Korean Patent Publication No. 10-2016-0128061, the ‘Bluetooth device’ which corresponds to an earphone is accommodated in a smartphone through a ‘slide rail’ formed in the smartphone.

In order to accommodate the earphone in the smartphone through the slide rail, a predetermined space, excepting a display screen, on the entire front surface of the smartphone is required. If the required space is secured, there are several problems in that the display screen is narrowed and in that the entire design of the smartphone is disfigured.

Furthermore, not directly related to the present invention, but Korean Patent Publication No. 10-2005-0111719 discloses a ‘mobile terminal having retractable connector’. In FIGS. 1 and 2 of Korean Patent Publication No. 10-2005-0111719, a ‘manual button 66’ for discharging a connector is formed by a connector storage unit to protrude outward from the outside of a mobile phone to a predetermined length.

The ‘manual button’ is a device for discharging the connector outward. Only when a user directly presses the ‘manual button’ protruding outward from the mobile phone to the predetermined length with the hand. (The mobile terminal has a structure that cannot discharge the connector without the ‘manual button’ protruding outward from the mobile phone to a predetermined length, and that the connector cannot be discharged out when only the connector is pressed without the ‘manual button’ protruding outward, and that can never receive and discharge the connector when the user touches only the connector even if the manual button is arranged inside the rear surface of the connector storage unit.)

In the case of Korean Patent Publication No. 10-2005-0111719, the ‘manual button’ must be formed to protrude outward from the mobile phone to a predetermined length. However, in the case in which the ‘manual button’ is formed to protrude outward from the mobile phone to the predetermined length, the protruding portion of the manual button is caught to a user’s hand when the user uses the mobile phone.

In addition, Korean Patent Publication No. 10-2005-0111719 has a disadvantage in that the design of the smartphone is disfigured since the ‘manual button’ protrudes outward from the mobile phone to the predetermined length. Accordingly, a smartphone having an earphone storage unit which does not have an influence on the design of a smartphone and is convenient in use.

### DISCLOSURE

### Technical Problem

Accordingly, the present invention has been made in view of the above-mentioned problems occurring in the related art, and it is an object of the present invention to provide a smartphone of a new concept unlike the conventional smartphone.

### Technical Solution

To accomplish the above-mentioned objects, according to the present invention, there is provided a smartphone having an earphone storage unit including: at least one an earphone storage unit formed in a cylindrical shape; and an earphone withdrawing unit for facilitating the withdrawal of an earphone stored in the earphone storage unit.

The earphone withdrawing unit includes: a cylinder; a shaft reciprocating in the cylinder; a knock member rotating in response to the shaft whenever the shaft is pressed; and

an elastic member pushing the knock member outward in response to the knock member.

Moreover, according to an embodiment of the present invention, the cylinder has guide grooves and guide protrusions formed inside the cylinder in a longitudinal direction.

The shaft has a moving protrusion moving along the guide groove in response to the guide groove.

Furthermore, according to an embodiment of the present invention, the knock member has a knock protrusion moving along the guide groove in response to the guide groove, and the knock member rotates at a predetermined angle whenever the shaft reciprocates once.

In order to solve the above problems, according to an embodiment of the present invention, there is provided a smartphone having an earphone storage unit including: at least one an earphone storage unit formed in a cylindrical shape; and an earphone withdrawing unit for facilitating the withdrawal of an earphone stored in the earphone storage unit.

The earphone withdrawing unit includes: a shaft reciprocating when the earphone is withdrawn from the earphone withdrawing unit; and a locking fixing portion for making the shaft locked and fixed by a hook while the shaft performs a reciprocating motion.

Additionally, according to an embodiment of the present invention, the locking fixing portion includes: a hook moving path through which the hook of a hanging portion moves; and a locking portion for locking the locking fixing portion while the hook of the hanging portion moves along the hook moving path.

In addition, according to an embodiment of the present invention, the locking fixing portion further includes: a first slope, a second slope, a third slope, a fourth slope, and a fifth slope for guiding the hook to move along the plurality of hook moving paths.

Moreover, according to an embodiment of the present invention, the locking fixing portion further includes: a first hook guide groove for guiding the hook to a second hook moving path; and a second hook guide groove for guiding the hook to a fourth hook moving path.

Furthermore, according to an embodiment of the present invention, the hook moving path includes: a first hook moving path through which the hook of the hanging portion moves; a second hook moving path extended and connected to the first hook moving path; a third hook moving path extended and connected to the second hook moving path; a fourth hook moving path extended and connected to the third hook moving path; and a locking portion formed between the second hook moving path and the third hook moving path.

Alternatively, the hook moving path includes: a fifth hook moving path through which the hook of the hanging portion moves; a sixth hook moving path extended and connected to the fifth hook moving path; a seventh hook moving path extended and connected to the sixth hook moving path; and a locking portion formed between the fifth hook moving path and the sixth hook moving path.

Additionally, according to an embodiment of the present invention, the locking fixing portion includes: a cylinder; and a rotational movement path which is formed in the cylinder and through which the hook of the shaft moves.

The shaft performs a reciprocating motion while rotating in the cylinder, and has a hook moving through the rotational movement path.

In addition, according to an embodiment of the present invention, the smartphone having an earphone storage unit further includes: a hanging portion formed integrally with the shaft or formed separately from the shaft to fix the shaft by locking the locking fixing portion.

Moreover, according to an embodiment of the present invention, the locking fixing portion includes: a locking fixing protrusion caught to the hook of the hanging portion to be fixed in a state in which the shaft is inserted; and a separation slope moving to separate the hook of the hanging portion from the locking fixing protrusion.

Furthermore, according to an embodiment of the present invention, the locking fixing portion further includes: a locking slope formed on the locking fixing protrusion to guide the hook of the hanging portion to be introduced into the locking fixing protrusion.

Additionally, according to an embodiment of the present invention, the earphone withdrawing unit further includes: a hook separation guide portion for holding the hook when the hook of the hanging portion moves along the separation slope to be separated from the locking fixing protrusion and moves to a guide slope.

In addition, according to an embodiment of the present invention, the hook separation guide portion includes: a guide slope for guiding the second hook to be easily introduced into the hook separation guide portion; a guide locking protrusion for locking the second hook of the hanging portion; and a guide movement path for guiding movement of the second hook which is introduced into the hook separation guide portion.

Moreover, according to an embodiment of the present invention, the locking fixing portion further includes: a locking fixing protrusion caught to the hook of the hanging portion to be fixed in a state in which the shaft is inserted; and a locking release portion for separating the hook of the hanging portion from the locking fixing protrusion.

### Advantageous Effects

As described above, a smartphone user usually carry a Bluetooth earphone and a charger. However, according to the smartphone having the earphone storage unit according to the embodiment of the present invention, the smartphone user does not carry the smartphone and the Bluetooth earphone separately but carries only the smartphone to obtain an effect of carrying the smartphone and the Bluetooth earphone at the same time since the Bluetooth earphone is accommodated in the smartphone.

Moreover, since the Bluetooth earphone is automatically recharged when only the smartphone is recharged without recharging the Bluetooth earphone, thereby removing inconvenience to recharge the smartphone and the Bluetooth earphone separately.

In addition, since the Bluetooth earphone is automatically recharged when being stored in the smartphone, additional storage device and charging device are not required, so the smartphone having the earphone storage unit according to the embodiment of the present invention can provide an economic effect by reducing budgets for producing storage devices and charging devices.

### DESCRIPTION OF DRAWINGS

FIG. 1 is a perspective view illustrating a smartphone having an earphone storage unit according to an embodiment of the present invention.

FIG. 2 is an enlarged schematic diagram illustrating the inside of the earphone storage unit and the inside of an earphone withdrawing unit according to an embodiment of the present invention.

FIG. 3 is an exploded view of the earphone withdrawing unit according to an embodiment of the present invention.

FIG. 4 is a schematic diagram illustrating a state in which a shaft is discharged in an assembled state of FIG. 3.

FIG. 5 is a schematic diagram illustrating a state in which the shaft is inserted in the assembled state of FIG. 3.

FIG. 6 is a schematic diagram illustrating another example of FIG. 4 according to an embodiment of the present invention.

FIG. 7 is an enlarged view illustrating a knock member according to an embodiment of the present invention.

FIG. 8 is a cross-sectional view illustrating a cylinder and the knock member according to an embodiment of the present invention.

FIG. 9 is an internal surface development view illustrating a knock member operation process of changing the knock member from a discharge state into a fixed insertion state according to an embodiment of the present invention.

FIG. 10 is an exploded enlarged view illustrating an earphone withdrawing unit according to another embodiment of the present invention.

FIG. 11 is an enlarged view of the earphone withdrawing unit for depicting assembly and operation states of FIG. 10.

FIG. 12 is an enlarged schematic diagram for depicting a locking fixing portion according to another embodiment of the present invention.

FIG. 13 is an exploded and enlarged view for depicting an earphone withdrawing unit according to another embodiment of the present invention.

FIG. 14 is an exploded view of an earphone withdrawing unit according to an embodiment of the present invention.

FIG. 15 is an enlarged internal surface development view in which one side is cut and spread from P to S of a cylindrical shape of FIG. 14.

FIG. 16 is an enlarged view of an earphone withdrawing unit according to an embodiment of the present invention.

FIG. 17 is a schematic diagram for depicting an operational process of the earphone withdrawing unit of FIG. 16.

FIG. 18 is an enlarged schematic diagram for depicting the inside of an earphone withdrawing unit according to another embodiment of the present invention.

FIG. 19 is an enlarge schematic diagram for depicting the inside of an earphone withdrawing unit according to another embodiment of the present invention.

FIG. 20 is a schematic diagram for depicting an operational process of the earphone withdrawing unit of FIG. 19.

FIG. 21 is a schematic diagram for depicting the rear surface of a hook portion of a hanging portion of FIG. 19.

FIG. 22 is an enlarged schematic diagram for depicting the inside of the earphone storage unit according to another embodiment of the present invention.

### MODE FOR INVENTION

Hereinafter, a smartphone having an earphone storage unit according to an embodiment of the present invention will be described in detail with reference to the accompanying drawings.

In the description of the present invention, when it is judged that detailed descriptions of known functions or structures related with the present invention may make the essential points vague, the detailed descriptions of the known functions or structures will be omitted.

In the description of the present invention, to connect some part with another part means that some part is directly connected with another part and that some part is indirectly connected with another part through an element.

The embodiments are provided so that those skilled in the art may easily understand the technological spirit of the present invention and the present invention is not restricted by the embodiments. Furthermore, contents represented in the accompanying drawings have been diagrammed in order to easily describe the embodiments of the present invention, and may be different from forms that are actually implemented.

Furthermore, an expression that some elements are “included” is an expression of an “open type”, and the expression simply denotes that the corresponding elements are present, but should not be construed as excluding additional elements.

In the following description, terms such as “... portion”, “... device”, and “... module” indicate a portion for processing at least one function or operation, wherein the portion and the block may be embodied as hardware or software or embodied by combining hardware and software.

As used herein, the singular forms “one”, “a”, “an”, and “the” are intended to include the plural forms as well, unless the context clearly indicates otherwise.

It will be understood that terms, such as “first” or “second” may be used in the specification to describe various components but are not restricted to the above terms. The terms may be used to discriminate one component from another component.

Furthermore, terms to be described later are defined in consideration of the functions of the present invention, and may differ depending on the intentions of a user or an operator or custom. Accordingly, such terms should be defined on the basis of the contents of the overall specification.

In the present invention, an ‘earphone withdrawing unit 300’ means a device for withdrawing an earphone 400 from an earphone storage unit 200 when a user presses and releases the earphone 400 in an insertion direction 400s in order to withdraw the earphone 400 stored in the earphone storage unit 200.

In the present invention, the ‘earphone withdrawing unit 300’ has the name since serving to withdraw the earphone 400 from the earphone storage unit 200.

In the present invention, ‘pressing and releasing the earphone 400’ means to release an earphone grip portion after pressing the earphone grip portion to a predetermined distance or more (generally, about 5 mm) so that the earphone withdrawing unit 300 can operate.

In addition, in the present invention, ‘locking fixing portions 360 and 500’ serve to fix a shaft 320 when hooks 363a of hanging portions 363 and 510 catch the shaft in a state in which the shaft 320 is inserted while reciprocating.

Furthermore, all devices to discharge or withdraw the earphone 400 from the earphone storage unit 200 when the user presses and releases the earphone may correspond to the earphone withdrawing unit 300.

Hereinafter, the smartphone having the earphone storage unit according to the present invention will be described in detail with reference to the accompanying drawings.

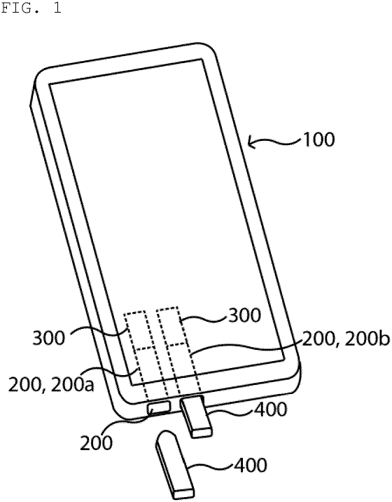

First, referring to FIG. 1, the earphone storage unit 200 of a long cylindrical shape includes a first earphone storage unit 200a and a second earphone storage unit 200b formed at one side of a smartphone body 100 in a plurality of ‘ | | ’ shapes, and the earphone 400 is inserted into the earphone storage unit 200.

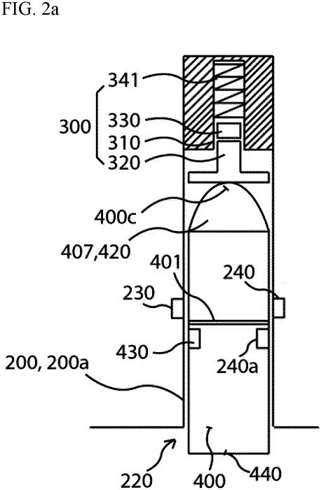

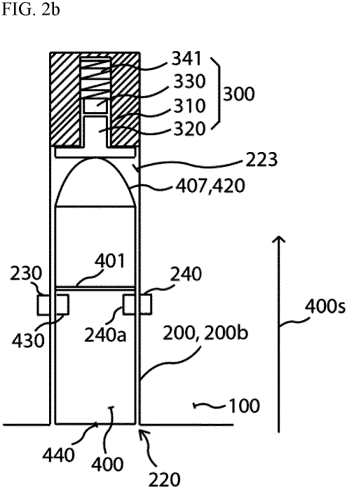

Referring to FIG. 2, the earphone storage unit 200 has the plurality of earphone storage units of the long cylindrical shape, and the earphone withdrawing unit 300 is formed at a rear end opposite to an earphone storage unit inlet 220 to facilitate withdrawal of the earphone 400 from the earphone storage unit 200.

In addition, as illustrated in FIG. 2B, an earphone charging terminal 230 is formed on the earphone storage unit 200 so as to charge an earphone battery in a state in which the earphone 400 is accommodated in the earphone storage unit 200, and a corresponding charging terminal 430 corresponding to the earphone charging terminal 230 is formed on the earphone 400.

Moreover, a magnet 240 is formed on one side of the earphone storage unit 200 and the earphone 400 to fix the earphone 400 when the earphone 400 is accommodated in the earphone storage unit 200, and a magnet 240a or a magnetic material 240a attached to the magnet is formed on the other side of the earphone storage unit 200 and the earphone 400.

Instead of the magnet, an elastic fixing protrusion (not shown) may be formed on the earphone storage part 200, and a fixing groove (not shown) may be formed in the earphone 400, so when the earphone 400 is accommodated, the fixing protrusion may be elastically inserted into the fixing groove to fix the earphone 400.

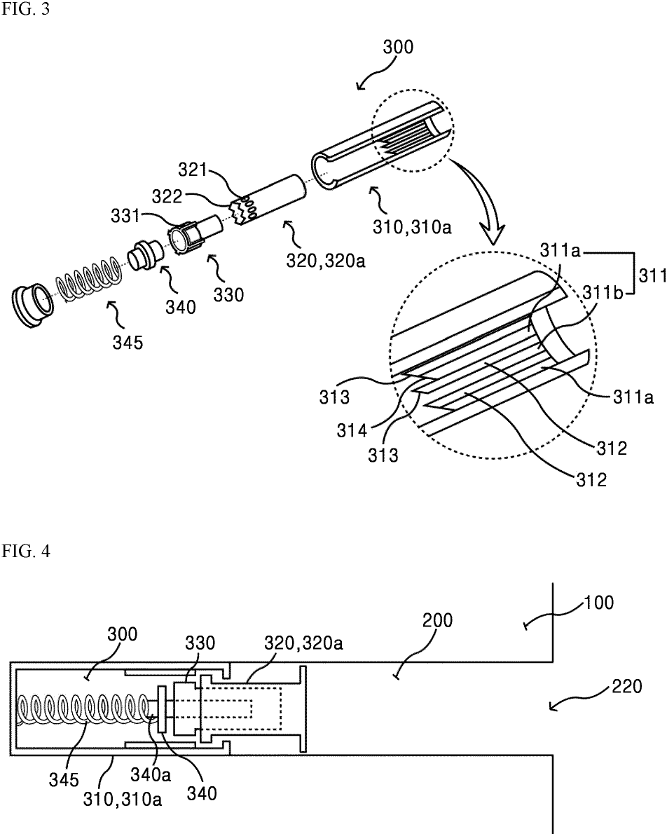

FIG. 3 is an exploded view of the earphone withdrawing unit 300. The earphone withdrawing unit 300 includes a cylinder 310 that is an outer cover of the earphone withdrawing unit 300, a shaft 320 that reciprocates within the cylinder 310, a knock member 330 rotating whenever the shaft is pressed, and an elastic member 345 allowing the knock member 330 to reciprocate.

The cylinder 310 is formed in a substantially cylindrical shape.

The shaft 320 is mounted to move forward and backward in a longitudinal direction in a state in which a portion of the shaft 320 protrudes from an upper portion of the cylinder 310.

The knock member 330 is mounted between the shaft 320 and the elastic member 345.

While the knock member 330 rotates at a predetermined angle whenever the shaft 320 reciprocates once, a knock operation is performed in such a way that the shaft 320 is inserted into the cylinder 310 and maintains the inserted state or the shaft 320 is discharged from the cylinder 310 and maintains the discharged state.

The elastic member 345 is contracted when the shaft 320 is inserted into the cylinder 310, and is released when the shaft 320 is discharged from the cylinder 310.

In the configuration of the earphone withdrawing unit, the cylinder 310, the shaft 320, the knock member 330, and the elastic member 345 may be substituted by other components.

As illustrated in FIG. 3, a plurality of moving protrusions 321 are formed on the outer surface of the shaft 320 to be divided at a predetermined angle along the circumference of the shaft, and a plurality of guide grooves 311 and guide protrusions 312 are formed on the inner surface of a rear end of an upper portion of the cylinder 310 to be alternately arranged at predetermined intervals so as to guide the moving protrusions 321 to move forward and backward along the circumference. Referring to FIG. 8, the knock member 330 includes knock protrusions 331 protruding along the circumference to be spaced apart from each other at predetermined intervals as many as the number of first guide grooves 311a.

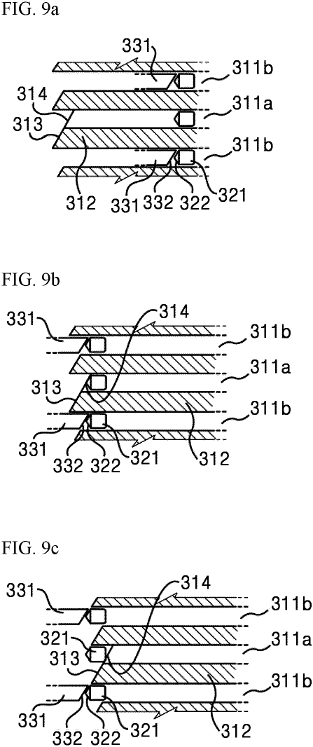

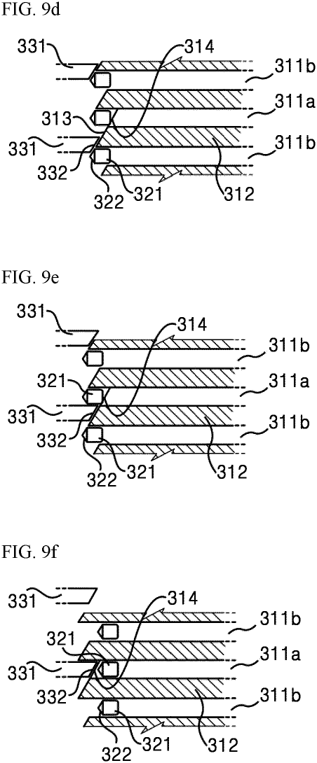

Referring to FIGS. 8 and 9, a rotational slope 313 is formed at one end of the guide protrusion 312 such that the knock member 330 rotates corresponding to an inclined surface 332 of the knock protrusion when the shaft is pressed.

Preferably, the shaft 320 has a substantially cylindrical shape and a plurality of triangular saw-teeth 322 may be formed at one end of the shaft 320. However, as occasion demands, the shaft may have other shapes instead of the saw-toothed shape.

The knock member 330 may have an approximately cylindrical shape.

The end of the knock protrusion 331 has an inclined surface 332 corresponding to the saw-teeth 322.

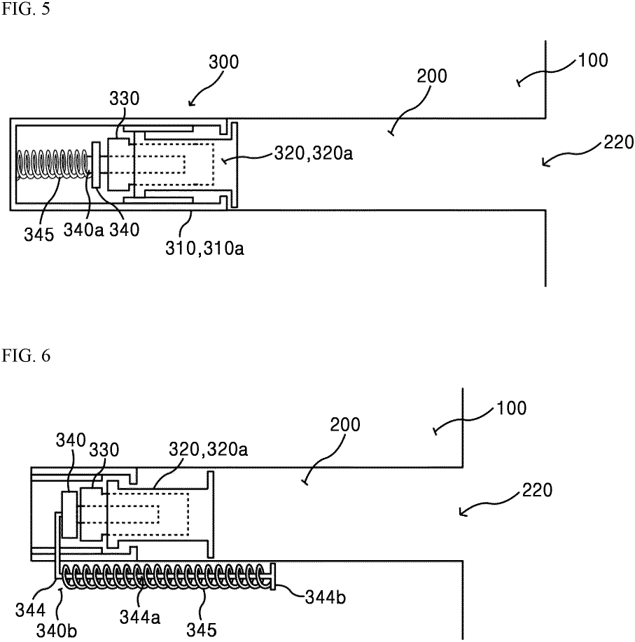

FIG. 4 is a schematic diagram illustrating a state in which a shaft is discharged in an assembled state of FIG. 3, and FIG. 5 is a schematic diagram illustrating a state in which the shaft is inserted in the assembled state of FIG. 3.

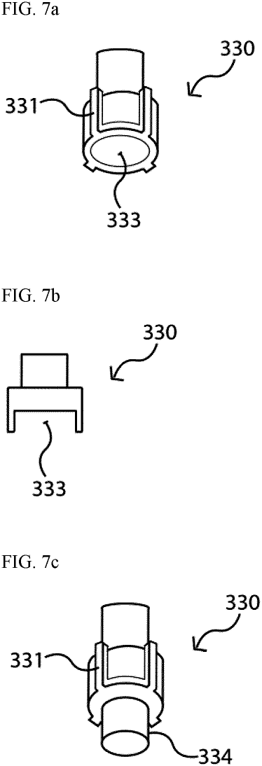

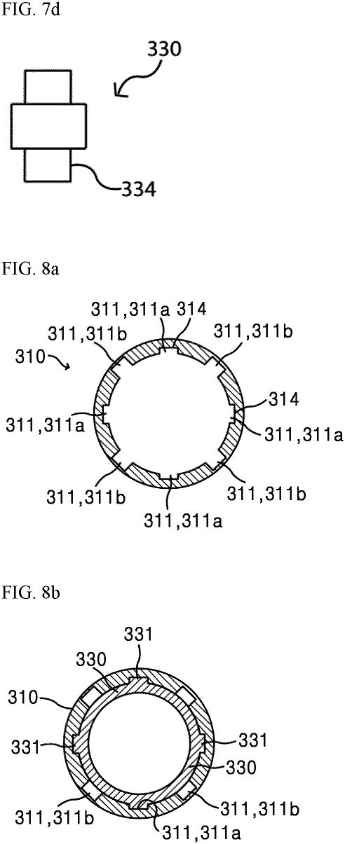

FIG. 6 is a schematic diagram illustrating another example of FIG. 4 according to an embodiment of the present invention, FIG. 7 is an enlarged view illustrating a knock member according to an embodiment of the present invention, FIG. 8 is a cross-sectional view illustrating a cylinder and the knock member according to an embodiment of the present invention, and FIG. 9 is an internal surface development view illustrating a knock member operation process of changing the knock member from a discharge state into a fixed insertion state according to an embodiment of the present invention.

Referring to FIGS. 1 to 9, a smartphone having an earphone storage unit according to an embodiment of the present invention will be described. The smartphone having an earphone storage unit includes: at least one earphone storage unit 200 of a cylindrical shape formed at one side of a smartphone body 100; and an earphone withdrawing unit 300 for facilitating withdrawal of an earphone 400 stored in the earphone storage unit 200.

The earphone withdrawing unit 300 includes: a cylinder 310; a shaft 320 reciprocating inside the cylinder 310; a knock member 330 rotating corresponding to the shaft 320 whenever the shaft 320 is pressed; and an elastic member 345 corresponding to the knock member 330 to push the knock member 330.

In order to withdraw the earphone 400 stored in the earphone storage unit 200, in a case in which a user presses and releases the earphone 44 in an earphone insertion direction 400s to a predetermined depth, the shaft 320 of the earphone withdrawing unit 300 is pushed out so that the earphone 400 is discharged.

Additionally, the cylinder 310 has guide grooves 311 and guide protrusions 312 formed in the cylinder in a longitudinal direction, and the shaft 320 has moving protrusions 321 moving along the guide grooves 311 in response to the guide grooves 311 to reciprocate in the cylinder 310.

In addition, the knock member 330 has knock protrusions 331 moving along the guide grooves 311 in response to the guide grooves 311. The knock member 330 rotates by a predetermined angle whenever the shaft 320 reciprocates once.

Moreover, the guide grooves 311 are different in depth from each other, wherein second guide grooves 311b are deeper than first guide grooves 311a.

Furthermore, the guide grooves 311 includes the first guide grooves 311a and the second guide grooves 311b, and the first guide grooves 311a respectively have locking jaws 314.

Additionally, the guide protrusion 312 includes a rotational slope 313 formed on one side thereof, and the shaft 320 includes saw-teeth 322 formed corresponding to slopes 332 of the knock protrusions 331 of the knock member 330 to rotate the knock member.

In addition, the knock member 330 includes a groove 333 into which one end of the elastic member 345 is inserted. The knock member 330 rotates in a state in which one end of the elastic member is inserted into the groove 333.

Moreover, the knock member 330 includes an elastic member insertion protrusion 334 inserted into an end of the elastic member 345, and the knock member 330 rotates in a state in which the elastic member insertion protrusion 334 is inserted into an end of the elastic member 345.

In the present invention, Referring to FIGS. 1 to 9, the operation of the earphone withdrawing unit 300 will be described. When the user presses and releases the earphone 400 in the earphone insertion direction 400s to a predetermined distance after inserting the earphone 400 into the earphone storage unit 200, as illustrated in FIG. 2A, an end of the earphone presses the shaft 320 so that the shaft 320 and the knock member 330 are pushed in. In the above state, when the knock member 330 rotates at a predetermined angle in response to the shaft 320, the knock protrusion 331 of the knock member 330 is caught to the locking jaw 314 of the first guide groove 311a of the cylinder in a state in which the shaft 320 is deeply inserted into the cylinder 310. The shaft 320 maintains the deeply inserted state, and as illustrated in FIG. 2B, the earphone 400 is accommodated.

As illustrated in FIG. 2B, in a state in which the earphone is stored in the earphone storage unit 200, when the user presses and releases the earphone in the earphone insertion direction 400s to a predetermined distance, the knock member 330 rotates at a predetermined angle in response to the shaft. Then, the knock protrusion 331 of the knock member is pushed out through the second guide groove 311b of the cylinder 310. When the knock protrusion 331 of the knock member is pushed out, as illustrated in FIG. 2A, the shaft 320 is pushed out by power generated when the knock member 330 is pushed out. Moreover, the earphone is discharged outward from the earphone storage unit 200 by power generated when the shaft is pushed out.

FIG. 7A is an enlarged view of the knock member according to an embodiment of the present invention, FIG. 7B is a cross-sectional view of FIG. 7A, FIG. 7C is an enlarged view illustrating a knock member of another embodiment, and FIG. 7D is a cross-sectional view of FIG. 7C. According to circumstances, the knock member can rotate in a state in which an end of the elastic member 345 is inserted into the groove 333 of the knock member 330 illustrated in FIG. 7A, or the elastic member insertion protrusion 334 illustrated in FIG. 7C is inserted into the elastic member 345.

Referring to FIGS. 3, 8, and 9, whenever the shaft 320 is pressed once, the knock member 330 rotates at a predetermined angle in a case in which the knock protrusions 331 of the knock member 330 correspond to the teeth 322 formed on the shaft 320.

Now, referring to FIG. 9, a rotation principle will be described in more detail. In a state in which the knock protrusion 331 is pushed out through the second guide groove 311b as illustrated in FIG. 9A,, when the shaft is pressed, the saw-teeth 322 of the shaft 320 touch the slope 332 of the knock protrusion 331.

When the shaft is pressed continuously in the state of FIG. 9A, the knock protrusion 331 is pushed in as illustrated in FIG. 9B. When the shaft is pressed further in the state of FIG. 9B, the slope 332 of the knock protrusion 331 reaches the rotational slope 313 of the guide protrusion 312 as illustrated in FIG. 9C.

In the state of FIG. 9C, the slope 332 of the knock protrusion 331 slides toward the slope of the saw-teeth 322, and then, continuously slides through the rotational slope 313 of the guide protrusion 312 as illustrated in FIG. 9D so as to be in the state illustrated in FIG. 9E. In this instance, while sliding, the knock member 330 and the knock protrusion 331 rotate at a predetermined angle due to the rotational slope 313.

In the state of FIG. 9E, since the saw-teeth 322 of the shaft 320 maintain the inserted state as illustrated in FIG. 9C, the knock protrusion 331 is caught to the moving protrusion 321 not to slide no more so that rotation of the knock protrusion 331 is stopped.

When the user releases the shaft pushed in the state of FIG. 9E, the moving protrusion 321 is pushed out as illustrated in FIG. 9F. Thereafter, the knock protrusion 331 caught to the moving protrusion 321 as illustrated in FIG. 9E continuously slides and rotates, and then, reaches the first guide groove 311a as illustrated in FIG. 9F. Thereafter, the knock protrusion is caught and fixed to the locking jaw 314 of the first guide groove 311a so that the shaft is inserted and fixed to the locking jaw 314 of the first guide groove 311a to fix the inserted shaft, thereby storing the earphone.

In the state in which the earphone is stored as illustrated in FIG. 9F, in order to withdraw the earphone, when the user presses the shaft to a predetermined distance, the knock protrusion 331 rotates as described above to reach the second guide groove 311b. Since the depth of the second guide groove 311b is greater than the size of the knock protrusion 331, as illustrated in FIG. 9A, the knock protrusion 331 is pushed out through the second guide groove 311b. That is, when the knock member 330 is pushed out, the shaft is also pushed out, and the earphone is withdrawn by power generated when the shaft is pushed out.

As described above, when the knock protrusion 331 is located in the first guide groove 311a while the knock member 330 and the knock protrusion rotate, the knock protrusion 331 is caught to the locking jaw 314 and is fixed in a state in which the shaft is pushed in. When the knock protrusion 331 is located in the second guide groove 311b, the shaft is released and is pushed out.

Additionally, the first guide groove 311a may form the locking jaw 314 on which the knock protrusion 331 is caught. As occasion demands, the guide groove 311 includes the first guide groove 311a and the second guide groove 311b having the same depth, is bigger than the knock protrusion 331, and the locking jaw 314 may be formed on the first guide groove 311a.

FIG. 6 is a schematic diagram illustrating another example of FIG. 4 according to an embodiment of the present invention. In order to reduce a mounting space of the earphone withdrawing unit, a knock member support 340 for supporting the knock member 330 is further included.

The elastic member 345 may be formed at a rear portion 340a of the knock member support 340 which is connected with an end of the elastic member 345, or may be formed on a side 340b of the knock member support 340, so that the knock member 330 can be rotated on the knock member support 340.

In a case in which the elastic member 345 is formed on the side 340b of the knock member support 340, the elastic member 345 is operated by the elastic member operating portion 344. An extension portion 344a of the elastic member operating portion 344 is elongated along the inside of the elastic member 345 so that an elastic member locking portion pushes and compresses an end of the elastic member 345.

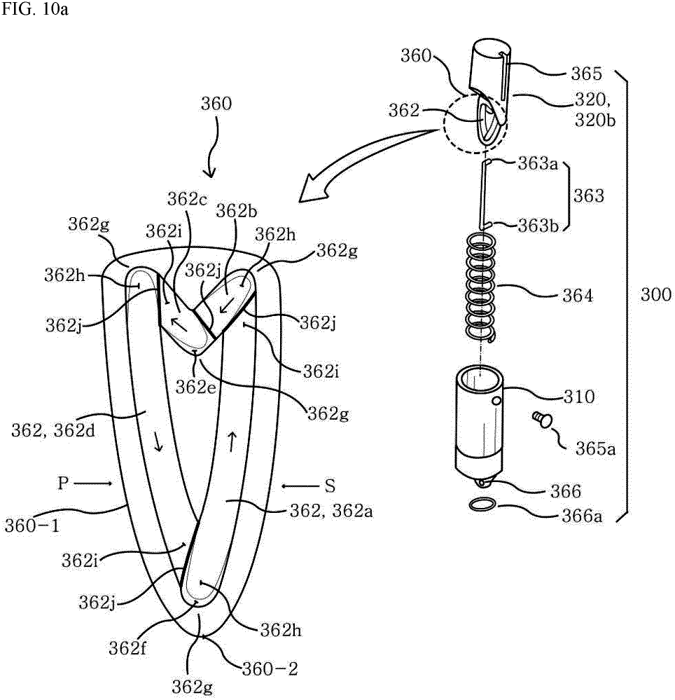

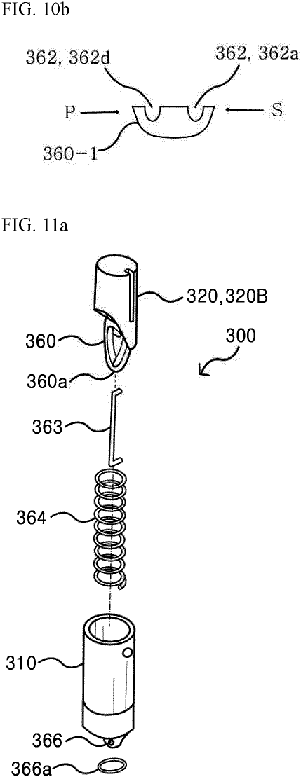

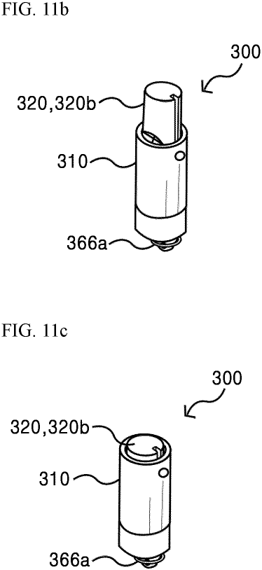

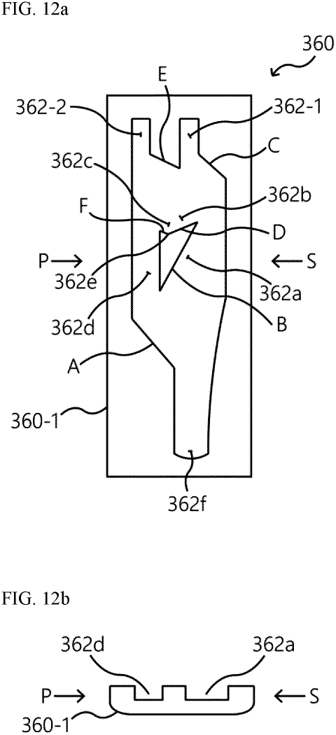

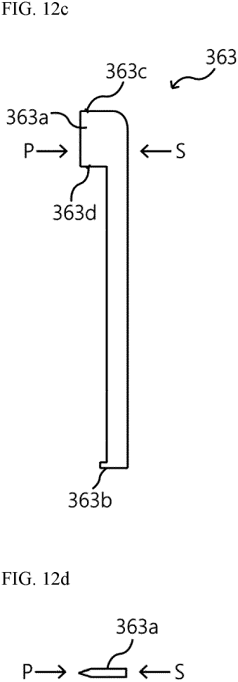

FIG. 10 is an exploded enlarged view of the earphone withdrawing unit according to another embodiment of the present invention, wherein FIG. 10A is an enlarged view of a locking fixing portion, FIG. 10B is a sectional view from P to S of FIG. 10A. FIG. 11 is an enlarged view of an earphone withdrawing unit for depicting assembly and operation states of FIG. 10. FIG. 12A is an enlarged schematic diagram of a locking fixing portion according to another embodiment of the present invention, FIG. 12B is a sectional view from P to S of FIG. 12A, FIG. 12C is an enlarged schematic diagram of a hanging portion according to another embodiment of the present invention, and FIG. 12D is a sectional view from P to S of FIG. 12C.

Referring to FIGS. 10 to 12, the earphone withdrawing unit 300 includes a shaft 320 or 320b which reciprocates when the earphone is withdrawn from the earphone storage unit 200, a locking fixing portion 360 which is integrally formed with the shaft 320 or 320b or is spaced apart from the shaft 320 or 320b and is caught to a hanging portion 363 while the shaft reciprocates; and the hanging portion 363 for locking and fixing the locking fixing portion 360.

In addition, the locking fixing portion 360 includes: a hook moving path 362 in which a hook 363a of the hanging portion 363 moves; and a locking portion 362e to which the locking fixing portion 360 is caught while the hook 363a of the hanging portion moves along the hook moving path 362. The hanging portion 363 has the hook 363a formed at an end 363a thereof.

Moreover, the earphone withdrawing unit further includes: a cylinder 310 in which the shaft 320 or 320b reciprocates; and an elastic member 364 by which the shaft 320 or 320b is pushed out. The elastic member 364 may be a spring, and is formed below the locking fixing portion 360 or formed on a side of the locking fixing portion 360.

Furthermore, in an embodiment of the present invention, the hook moving path 362 is formed in a heart shape, and includes: a first hook moving path 362a through which the hook 363a of the hanging portion moves; a second hook moving path 362b extended and connected to the first hook moving path; a third hook moving path 362c extended and connected to the second hook moving path; and a fourth hook moving path 362d extended and connected to the third hook moving path. The locking portion 362e is formed between the second hook moving path and the third hook moving path.

In addition, the earphone withdrawing unit may further include a second locking portion 362f formed between the fourth hook moving path 362d and the first hook moving path 362a.

Moreover, as illustrated in FIG. 10B, the hook moving path 362 is formed as a U-shaped groove. Among the hook moving paths located at both sides of the locking portion 362e, one path through which the hook 363a of the hanging portion moves is deeper to a predetermined depth than the other path to a predetermined distance from the locking portion.

Referring to FIGS. 1 and 2, the configuration and operational process of FIG. 10 will be described in more detail. In order to store the earphone 400 in the earphone storage unit 200, when the user insert the earphone 400 and presses the earphone to a predetermined depth, an end of the earphone touches the shaft 320 or 320b.

In this instance, when the user presses the earphone 400 further, the shaft 320 or 320b is pushed inward and the hook 363a formed on the hanging portion moves in the first hook moving path 362a formed in a U-shape as illustrated in FIG. 10B, which is a sectional view from P to S of FIG. 10A, and then, reaches a vertex 362g where the first hook moving path 362a and the second hook moving path 362b meet.

When the user releases the earphone 400, the hook moving path 362 moves upward by elasticity of the elastic member 364, and the hook 363a moves to the second hook moving path 362b and is caught to the locking portion 362e so that the locking fixing portion 360 is fixed in a state in which the shaft 320b is retracted. Accordingly, the earphone 400 is stored in the earphone storage unit 200.

As described above, the hook 363a moves to the second hook moving path 362b through the first hook moving path 362a since one path through which the hook 363a of the hanging portion moves, among both hook moving paths from the vertex 362g, is deeper than the other path and a movement guide protrusion 362j is formed at a predetermined position of the vertex 362g. So, when the hook 363a reaches the vertex 362g, the hook 363a is naturally guided to the second hook moving path 362b by the depth of the path or the movement guide protrusion 362j so as to move in the second hook moving path 362b.

As described above, in the state in which the earphone 400 is stored in the earphone storage unit 200, when the user presses the earphone 400 in the earphone insertion direction 400s to withdraw the earphone 400, the hook 363a moves to the third hook moving path 362c while the hook moving path 362 moves inward, and then, reaches the vertex 362g where the third hook moving path 362c and the fourth hook moving path 362d.

In this instance, when the user releases the earphone 400, the hook moving path 362 is pushed out by elasticity of the elastic member 364, and the hook 363a moves to the fourth hook moving path 362d to be caught to the second locking portion 362f.

When the hook 363a is caught to the second locking portion 362f, the shaft 320 is pushed out. When the shaft 320 is pushed out, an earphone grip portion 440 is discharged from the earphone storage unit 200.

As described above, the hook 363a moves to the fourth hook moving path 362d through the third hook moving path 362c since one path through which the hook 363a of the hanging portion moves, among both hook moving paths from the vertex 362g, is deeper than the other path and a movement guide protrusion 362j is formed at a predetermined position of the vertex 362g. So, when the hook 363a reaches the vertex 362g, the hook 363a is naturally guided to the second hook moving path 362b by the depth of the path or the movement guide protrusion 362j so as to move in the second hook moving path 362b.

In addition, in the case in which the shaft 320 or 320b reciprocates inside the cylinder 310, since the hook 363a of the hanging portion 363 moves in the hook moving path 362 in response to the shaft, the shaft 320 or 320b must perform only the reciprocating motion while not being rotated.

In order to make the shaft 320 or 320b perform only the reciprocating motion in the cylinder 310 while not being rotated, a rotation prevention groove 365 is formed in one side of the shaft 320 or 320b in a longitudinal direction, and a rotation prevention protrusion 365a formed corresponding to the rotation prevention groove 365 so that the shaft 320b is not rotated.

That is, in a state in which the shaft 320 or 320b is assembled to the cylinder 310, the rotation prevention protrusion 365a formed on the cylinder 310 is inserted into the rotation prevention groove 365 formed in the shaft 320b so that the shaft 320b can perform only the reciprocating motion without rotation by the rotation prevention protrusion 365a. As occasion demands, the rotation prevention groove 365 may be formed in the cylinder 310, and the rotation prevention protrusion 365a may be formed on the shaft 320b.

FIG. 11A is an exploded view of the earphone withdrawing unit 300 of FIG. 10, FIG. 11B is a view illustrating a state in which the shaft 320 or 320b assembled is pushed out, and FIG. 11C is a view illustrating a state in which the shaft 320 or 320b of FIG. 11B is retracted.

FIG. 12 is a view illustrating a locking fixing portion 360 and a hook 363a of the hanging portion 363 according to a modification of FIG. 10. Referring to FIG. 12, the locking fixing portion 360 includes a first slope A, a second slope B, a third slope C, a fourth slope D, and a fifth slope E for guiding the hook 363a to move in a plurality of hook moving paths. The locking fixing portion 360 further includes: a first hook guide groove 362-1 for guiding the hook 363a to the second hook moving path 362b; and a second hook guide groove 362-2 for guiding the hook 363a to the fourth hook moving path 362d.

In FIG. 10, in order to make the hook 363a of the hanging portion move in each hook moving path, the hook moving paths are different in depth at vertexes 362g and movement guide protrusions 362j are respectively formed at the vertexes. However, even if the hook moving paths are not different in depth at vertexes 362g and movement guide protrusions 362j are not formed in FIG. 12, in order to make the hook 363a of the hanging portion move in each hook moving path, the plurality of slopes A, B, C, D, E and F are formed.

Additionally, a length between an upper end 363c of the hook and a lower end 363d of the hook is formed long so that the hook 363a of the hanging portion 363 can slide along each slope to correspond to the next slope.

Furthermore, in order to move the hook 363a along the slopes A, B, C, D, E and F only in one direction, the length between the upper end 363c of the hook and the lower end 363d of the hook corresponds lengths among the slopes A, B, C, D, E and F to form a length allowing the hook to move only in one direction.

That is, in a case in which the lower end 363d of the hook is positioned at the first slope A, the upper end 363c of the hook is caught to the second slope B. Before the lower end 363d of the hook moves to the fourth slope D through the second slope B, the upper end 363c of the hook is inserted into a first hook guide groove 362-1 while sliding corresponding to the third slope C.

In a case in which the hook 363a is pushed out from the first hook guide groove 362-1, the lower end 363d of the hook slides by being caught to the fourth slope D while the hook 363a is pushed out to the normal position by the first hook guide groove 362-1, and then, is caught to the locking portion 362e without sliding anymore due to the sixth slope F. Thereafter, the earphone is stored in the earphone storage unit. When the user presses the earphone again, the upper end 363c of the hook slides corresponding to the fifth slope E and is inserted into the second hook guide groove 362-2.

In this instance, when the user releases the earphone, the hook 363a is pushed out to the normal position by the second hook guide groove 362-2. When the hook reaches the locking portion 362f through the fourth hook moving path 362d, the earphone is withdrawn.

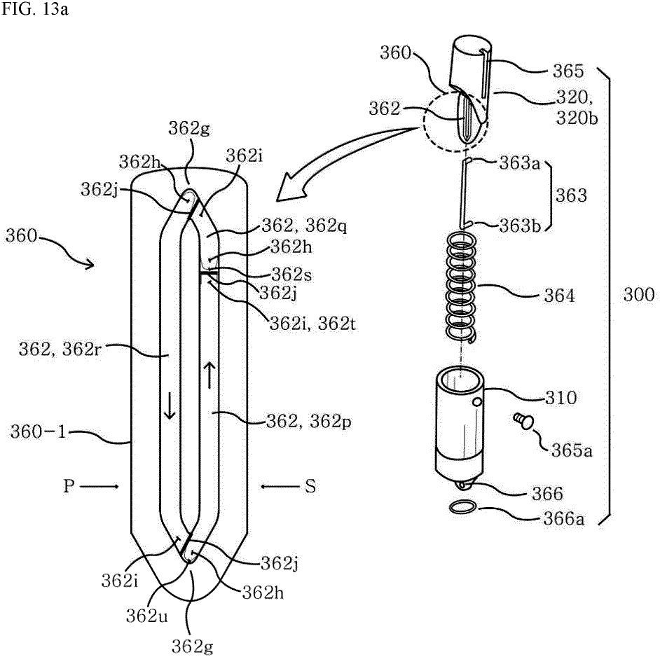

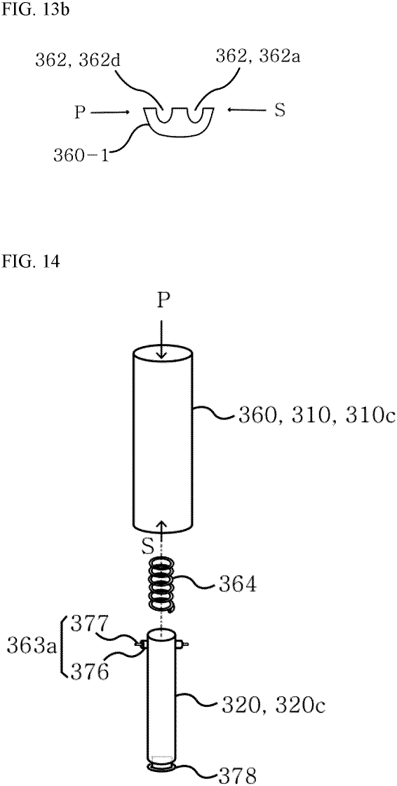

FIG. 13 is an exploded view of an earphone withdrawing unit according to another embodiment of the present invention. Referring to FIG. 13, unlike FIG. 10 illustrating the hook moving path 362 formed in a heart shape, the hook moving path 362 of FIG. 13 is formed in a ‘ | | ’ shape.

That is, the earphone withdrawing unit includes a cylinder 310, a shaft 320 or 320b reciprocating in the cylinder 310, a locking fixing portion 360 connected to the shaft, and an elastic member 364 allowing the shaft and a hanging portion 363 for locking and fixing the locking fixing portion to reciprocate.

In an embodiment of the present invention, the hook moving path 362 includes: a fifth hook moving path 362p through which the hook 363a of the hanging portion moves; a sixth hook moving path 362q extended and connected to the fifth hook moving path 362p; a seventh hook moving path 362r extended and connected to the sixth hook moving path 362q; and a locking portion 362s formed between the fifth hook moving path 362 and the sixth hook moving path 362q.

In addition, in an embodiment of the present invention, the locking fixing portion 360 includes a movement guide protrusion 362j formed at a vertex 362g between the sixth hook moving path 362q and the seventh hook moving path 362r, and a movement guide protrusion 362j formed at a vertex 362g between the seventh hook moving path 362r and the fifth hook moving path 362p.

The hook moving paths 362 located at both sides from the movement guide protrusion 362j are formed in such a way that one path through which the hook 363a of the hanging portion moves is deeper to a predetermined distance than the other path from the movement guide protrusion 362j.

In addition, the hanging portion 363 has a hook 363a formed at an end thereof, the other end 363b of the hanging portion 363 is fixed such that the hook is rotatable left and right. The hook 363a is caught to the locking portion 362s while moving along the hook moving path.

Referring to FIG. 13, the operation of the earphone withdrawing unit will be described. After the earphone 400 is stored in the earphone storage unit 200, when the user presses the earphone to a predetermined distance in the earphone insertion direction 400s and releases the earphone, the shaft 320 or 320b is inserted to a predetermined distance, and the hook 363a of the hanging portion is caught to the locking portion 362s through the fifth hook moving path 362p. When the hook 363a of the hanging portion is caught to the locking portion 362s, the shaft maintains the inserted state so that the earphone can be stored.

In the state in which the earphone is stored in the earphone storage unit 200, when the user presses the earphone to a predetermined distance in the earphone insertion direction 400s and releases the earphone, the shaft 320 or 320b is pushed in and out to a predetermined distance. Thereby, while the hook 363a of the hanging portion passes through the sixth hook moving path 362q and the seventh hook moving path 362r, the shaft 320b is pushed out, and the earphone is discharged out of the earphone storage unit by power that the shaft is pushed out.

In the present invention, the hook 363a of the hanging portion 363 rotates right and left when moving in the plurality of hook moving paths 362, since one end 363b of the hanging portion 363 is fit to a hanging portion fixture 366 and is fixed by a hanging portion fixing ring 366a not to escape from the hanging portion fixture, and the hanging portion fixture 366 and the inside of the cylinder 310 are perforated to respectively have spaces in which the hanging portion 363 can rotate right and left.

In the present invention, the hanging portion 363 and the hook 363a may have any one among various shapes and forms, all kinds of devices for locking and fixing the locking fixing portion 360 of the present invention may be the hanging portion 363 or the hook 363a.

In the present invention, preferably, the locking fixing portion 360 is formed integrally with the shaft 320. As occasion demands, the locking fixing portion 360 may be formed separately from the shaft or may be formed on the cylinder. That is, the locking fixing portion may be formed in one among various shapes and forms.

In addition, the operation of the shaft will be described. Preferably, the shaft performs a reciprocating motion in the state in which the hanging portion 363 is fixed. As occasion demands, it is possible that the shaft is fixed and the hanging portion 363 is formed to perform a reciprocating motion.

Furthermore, the shaft may perform a reciprocating motion in a state in which the locking fixing portion 360 is fixed. As occasion demands, it is possible that the shaft is fixed and the locking fixing portion 360 is formed to perform a reciprocating motion.

Additionally, the expression that the hook 363a of the hanging portion 363 moves in the hook moving path 362 means that the hook moving path 362 reciprocates corresponding to the hook 363a in a state in which the hanging portion 363 is fixed or that the hook 363a reciprocates corresponding to the hook moving path 362 in a state in which the hook moving path 362 is fixed. The hanging portion 363 may have one of various shapes and forms.

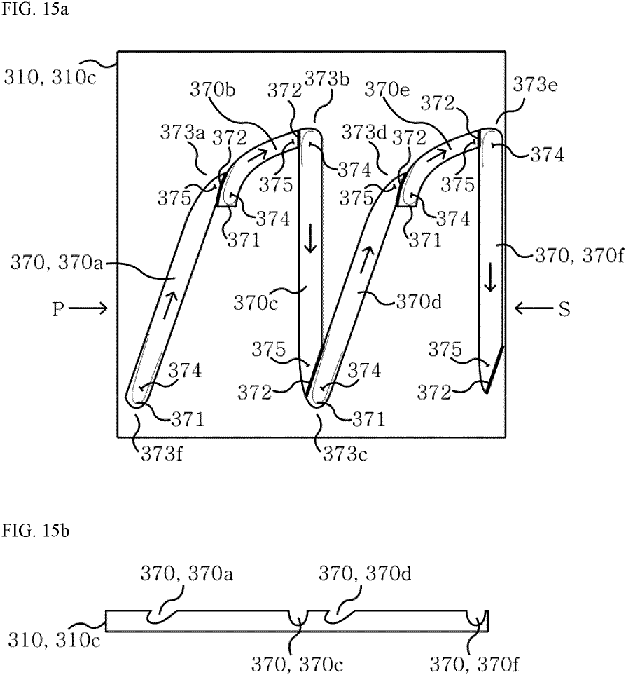

FIG. 14 is an exploded view of an earphone withdrawing unit according to another embodiment of the present invention, and FIG. 15 is an enlarged internal surface development view in which one side is cut and spread from P to S of a cylindrical shape of FIG. 14. Referring to FIGS. 14 and 15, a locking fixing portion 360 includes: a cylinder 310 or 310c; and a rotational movement path 370 which is formed in the cylinder and through which the hook 363a of the shaft moves.

The shaft 320 or 320c performs a reciprocating motion while rotating in the cylinder, and a hook moving in the rotational movement path is formed on the shaft. A rotational movement protrusion 376 which is the hook 363a, a protrusion adjusting portion 377, and a shaft support 378 are formed. A plurality of rotational movement paths 370 through which the hook 363a moves while rotating are formed in a U-shape. An elastic member 364 is formed to perform a reciprocating motion.

Moreover, at least one among the plurality of rotational movement paths 370 is formed in a diagonal form 370a so that the shaft 320 or 320c can rotate while performing a reciprocating motion.

In addition, the rotational movement path 370 further include a rotational locking portion 371 formed at any one among a point 373a where a first rotational movement path 370a and a second rotational movement path 370b meet each other, a point 373c where a third rotational movement path 370c and a fourth rotational movement path 370d meet each other, a point 373d where the fourth rotational movement path 370d and a fifth rotational movement path 370e meet each other, and a point 373f where the first rotational movement path 370a and a sixth rotational movement path 370f meet each other.

As illustrated in FIG. 15B, the rotational movement path 370 is formed in a U-shape. The rotational movement paths 370 located at both sides from the rotational locking portion 371 are formed in such a way that one path 374 through which the hook 363a moves is deeper to a predetermined distance than the other path 375 from the rotational locking portion 371.

In an embodiment of the present invention, the rotational movement paths 370 includes a first rotational movement paths 370a, a second rotational movement paths 370b, and a third rotational movement paths 370c. From the point 373b where the second rotational movement paths 370b and the third rotational movement paths 370c meet each other to a predetermined distance, one path 374 through which the hook 363a moves is deeper to a predetermined distance than the other path 375. The rotational movement paths 370 further includes a rotational movement guide protrusion 372 formed at the point 373b where the second rotational movement paths 370b and the third rotational movement paths 370c meet each other.

Referring to FIG. 15, the operation of the earphone withdrawing unit 300 will be described. In order to store the earphone 400, when the user presses the earphone 400 to a predetermined distance after inserting the earphone 400 into the earphone storage unit 200, the shaft 320 or 320c is pushed in while rotating, the hook 363a moves in the first rotational movement path 370a, and reaches the rotational locking portion 371 of the point 373a where the first rotational movement path 370a and the second rotational movement path 370b meet each other. When the rotational locking portion 371 is caught, the shaft 320 or 320c is fixed in an inserted state, so that the earphone 400 is stored.

In order to withdraw the earphone 400, when the user presses the earphone in the insertion direction, the hook 363a reaches the point 373b where the second rotational movement path 370b and the third rotational movement path 370c meet each other through the second rotational movement path 370b. When the user releases the earphone 400, the hook 363a reaches the point 373c where the third rotational movement path 370c and the fourth rotational movement path 370d meet each other through the third rotational movement path 370c, and the shaft 320 or 320c is pushed out so that the earphone is discharged from the earphone storage unit 200.

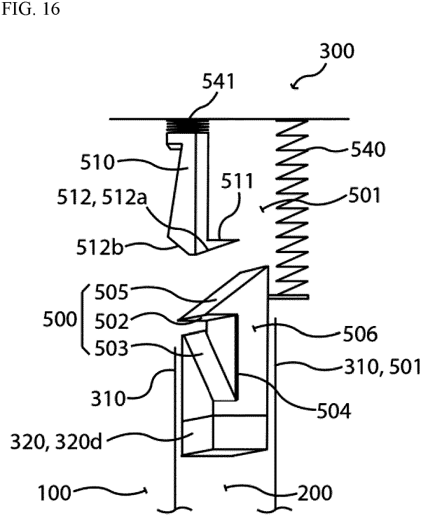

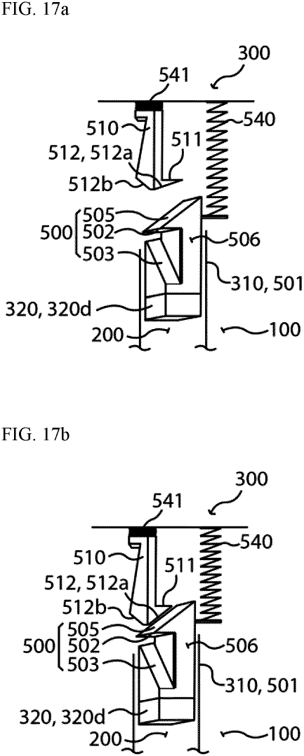

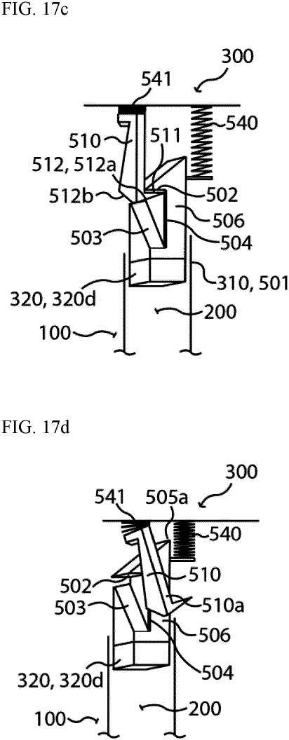

FIG. 16 is an enlarged view of an earphone withdrawing unit according to an embodiment of the present invention, and FIG. 17 is a schematic diagram for depicting an operational process of the earphone withdrawing unit of FIG. 16.

As illustrated in FIG. 16, whenever the user presses a shaft 320 or 320d performing a reciprocating motion when the earphone is stored or withdrawn, a locking fixing portion 500 for fixing and releasing the shaft is formed. A hook 511 of a hanging portion 510 for fixing the shaft by being caught to a locking fixing protrusion 502 of the locking fixing portion 500 is formed.

In addition, in order to release the hook 511 of the hanging portion 510, which is caught to the locking fixing protrusion 502, from the locking fixing protrusion 502, a separation slope 503 along which the hook 511 moves is formed.

Referring to FIGS. 16 and 17, an embodiment of the present invention will be described. The earphone withdrawing unit 300 includes: a shaft 320 or 320d which reciprocates when the earphone is withdrawn from the earphone storage unit 200; a locking fixing portion 500 which is integrally formed with the shaft 320 or 320d or is spaced apart from the shaft 320 or 320d to fix or release the shaft in a state in which the shaft 320 or 320d is retracted for a reciprocating motion; and a hanging portion 510 which is integrally formed with the shaft 320 or 320d or is spaced apart from the shaft 320 or 320d, and fixing the shaft by locking the locking fixing portion 500.

The locking fixing portion 500 further includes: a locking fixing protrusion 502 caught and fixed to the hook 511 of the hanging portion 510 in a state in which the shaft 320 or 320d is inserted; and a separation slope 503 on which the hook 511 of the hanging portion moves to be separated from the locking fixing protrusion 502.

Moreover, the locking fixing portion 500 further includes a locking slope 505 formed on the locking fixing protrusion 502 of the locking fixing portion 500 to guide the hook 511 of the hanging portion 510 to enter the locking fixing protrusion 502.

Furthermore, the locking fixing portion 500 further includes a locking separation path 506 formed on the side of the locking fixing protrusion 502.

The present invention further includes an elastic member 540 allowing the shaft 320 or 320d to perform a reciprocating motion. The elastic member 540 may be a spring, and may be preferably formed on the side of the locking fixing portion 500, but according to circumstances, may be formed at the back of the locking fixing portion 500.

Additionally, the hanging portion 510 may further include a second corresponding slope 512b corresponding to the separation slope 503.

Referring to FIG. 17, the operational process of the earphone withdrawing unit will be described in more detail. As illustrated in FIG. 17A, in a state in which the shaft 320 or 320d is pushed out before the earphone 400 is stored, when the user presses the earphone to a predetermined distance after inserting the earphone into the earphone storage unit 200, as illustrated in FIG. 17B, the shaft 320 or 320d is pushed in, and a first corresponding slope 512a of the hanging portion 510 touches the locking slope 505.

When the user presses further the earphone, the first corresponding slope 512a of the hanging portion 510 slides from the locking slope 505 to be inserted, and then, the hook 511 of the hanging portion 510 is caught to the locking fixing protrusion 502 as illustrated in FIG. 17C.

In this instance, due to elasticity of the elastic member 541 formed on the hanging portion, the first corresponding slope 512a slides from the locking slope 505, so the hook 511 of the hanging portion 510 is inserted in a lopsided state.

In the state of FIG. 17C, the earphone is stored in the earphone storage unit 200. When the user presses the earphone in order to withdraw the earphone, the hook 511 of the hanging portion 510 passes the separation slope 503 and is separated from a separation protrusion 504. Accordingly, as illustrated in FIG. 17D, the hook 511 of the hanging portion reaches the locking separation path 506.

In this instance, when the hook 511 of the hanging portion moves on the separation slope 503, the second corresponding slope 512b of the hanging portion 510 is slidably inserted along the separation slope 503 while the shaft is inserted so as to be separated from the locking separation protrusion 504.

In the state of FIG. 17D, when the user releases the pressed earphone, the hook 511 of the hanging portion 510 passes through the locking separation path 506, and the shaft is pushed out. In the state of FIG. 17A, the earphone is withdrawn from the earphone storage unit by power that the shaft is pushed out.

The locking slope 505 is preferably formed on the front surface of the locking fixing protrusion 502, but according to circumstances, the locking slope 505 may be formed on the side of the locking fixing protrusion 502.

Moreover, the separation slope 503 is formed to be inclined to the lateral side of the upper portion from an edge of the locking fixing protrusion 502, and the separation slope may be selectively formed leftward or rightward.

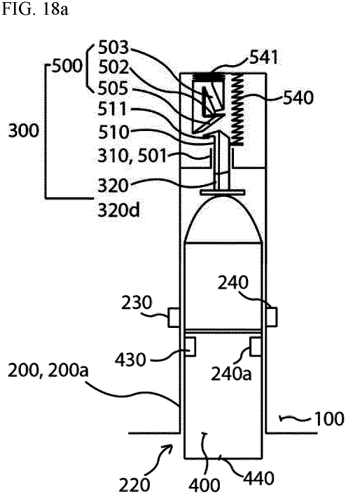

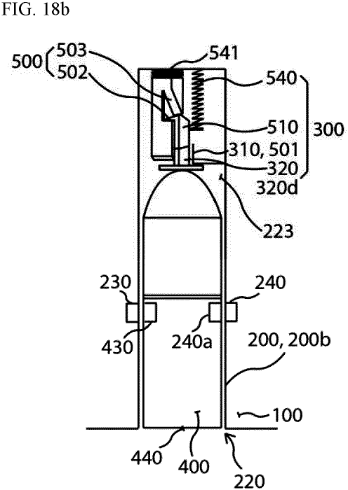

FIG. 18 is an enlarged schematic diagram for depicting the inside of an earphone withdrawing unit according to another embodiment of the present invention. Referring to FIG. 18A, the hanging portion 510 and the locking fixing portion 500 are formed on the contrary to FIG. 16. That is, the hanging portion 510 is formed integrally with the shaft 320 or 320d. Further detailed description will be omitted since being the same as the description of FIG. 16 (namely, detailed description is omitted to avoid repetition of description.)

Referring to FIG. 18B, unlike FIG. 16, the locking slope 505 of the locking fixing portion 500 is not formed. Instead of the locking slope 505, the locking fixing protrusion 502 is formed straight from an end portion thereof so that the hook 511 of the hanging portion 510 can move to the locking fixing protrusion 502. Further detailed description of other components except the locking slope 505 of FIG. 18A will be omitted since being the same as the above (namely, detailed description is omitted to avoid repetition of description.)

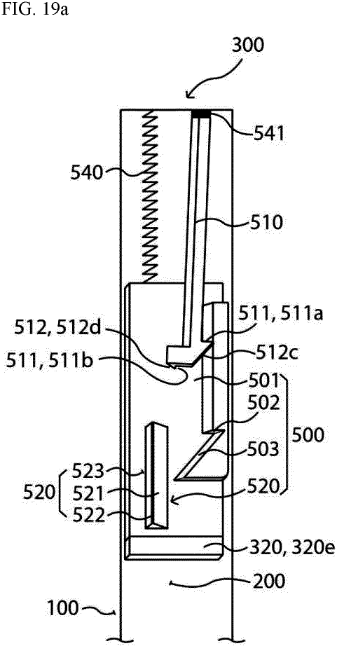

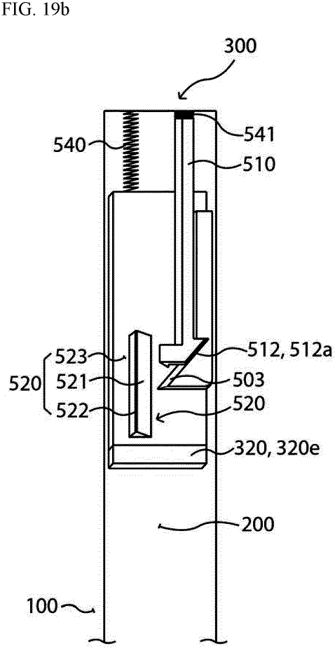

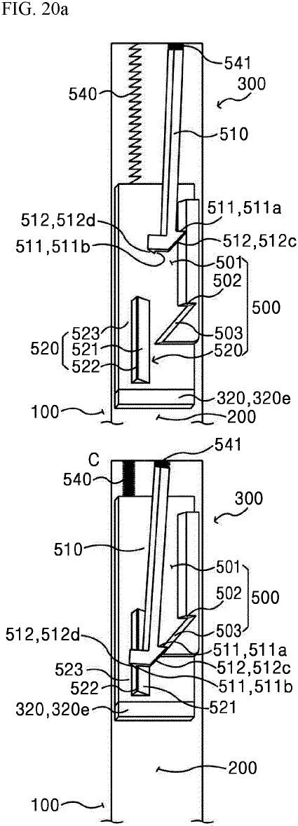

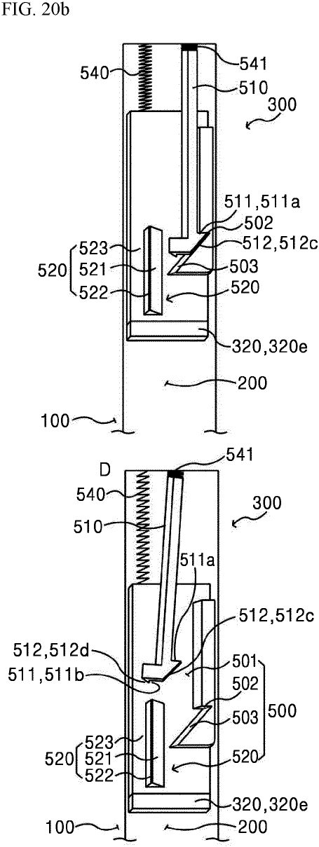

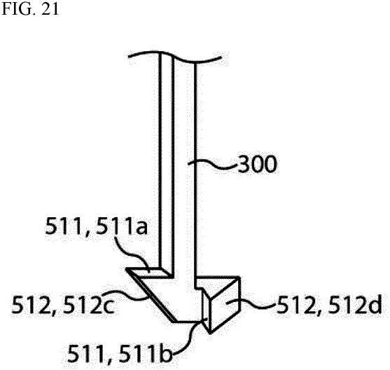

FIG. 19 is an enlarge schematic diagram for depicting the inside of an earphone withdrawing unit according to another embodiment of the present invention, FIG. 20 is a schematic diagram for depicting an operational process of the earphone withdrawing unit of FIG. 19, and FIG. 21 is a schematic diagram for depicting the rear surface of a hook portion of a hanging portion of FIG. 19.

Referring to FIGS. 19 to 21, unlike FIG. 16, a hook separation guide portion 520 is added to the hanging portion 510 and the locking fixing portion 500 of the earphone withdrawing unit 300. Accordingly, the hook 511 of the hanging portion 510 hung on a locking fixing protrusion 502 can be separated through the hook separation guide portion 520.

That is, in an embodiment of the present invention, the earphone withdrawing unit 300 further includes the hook separation guide portion 520 which holds a second hook 511b when a first hook 511a of the hanging portion 510 moves along a separation slope 503 to be separated from the locking fixing protrusion 502 and moves from the locking fixing protrusion 502 to a guide slope 521.

In addition, the hook separation guide portion 520 includes: a guide slope 521 for guiding the second hook 511b to be easily introduced into the hook separation guide portion 520; a guide locking protrusion 522 for locking the second hook 511b of the hanging portion 510; and a guide movement path 523 for guiding movement of the second hook 511b which is introduced into the hook separation guide portion 520.

Furthermore, the hook 511 of the hanging portion 510 includes: a first hook 511a caught to the locking fixing protrusion 502; and a second hook 511b caught to the guide locking protrusion 522 of the hook separation guide portion 520.

In the present invention, the hanging portion 510 includes a third corresponding slope 512c corresponding to the separation slope 503; and a fourth corresponding slope 512d corresponding to the guide slope 521.

Fixing and releasing principles of the locking fixing portion 500 of FIG. 20 will be described in more detail. As illustrated in FIG. 20A, in a state in which the shaft 320 or 320e is pushed out before the earphone is stored, when the user inserts the earphone into the earphone storage unit 200 and presses the earphone to a predetermined distance, the shaft 320 or 320e is pushed in, and then, the first hook 511a of the hanging portion 510 is caught to the locking fixing protrusion 502 as illustrated in FIG. 20B.

In this instance, the hook 511 of the hanging portion 510 is lopsided and is introduced into the locking fixing protrusion 502 by an elastic member 541 formed on the hanging portion so that the first hook 511a is caught to the locking fixing protrusion 502.

In the state of FIG. 20B, when the user stores the earphone in the earphone storage unit 200 and presses the earphone in order to withdraw the earphone, the first hook 511a of the hanging portion 510 is separated from the locking fixing protrusion 502 while passing the separation slope 503. Accordingly, as illustrated in FIG. 20C, the second hook 511b of the hanging portion is caught to the guide locking protrusion 522 after passing the guide slope 521 of the hook separation guide portion 520.

In this instance, when the first hook 511a of the hanging portion moves along the separation slope 503, the shaft 320 or 320e is inserted, and the third corresponding slope 512c slides corresponding to the separation slope 503 to be separated. Due to the separation power and the guide of the separation slope 503, the second hook 511b is caught to the guide locking protrusion 522 as illustrated in FIG. 20C.

As illustrated in FIG. 20C, when the second hook 511b is caught to the guide locking protrusion 522, the fourth corresponding slope 512d of the hanging portion 510 slides and moves corresponding to the guide slope 521.

In the state in which the second hook 511b is caught to the guide locking protrusion 522 as illustrated in FIG. 20C, when the second hook 511b slides by elasticity of the elastic member 540, the second hook 511b is separated from the hook separation guide portion 520 and moves toward a straight separation path 501 as illustrated in FIG. 20D. Then, the shaft 320 or 320e is pushed out and is in the state of FIG. 20A, so that the earphone is withdrawn from the earphone storage unit by power that the shaft is pushed out.

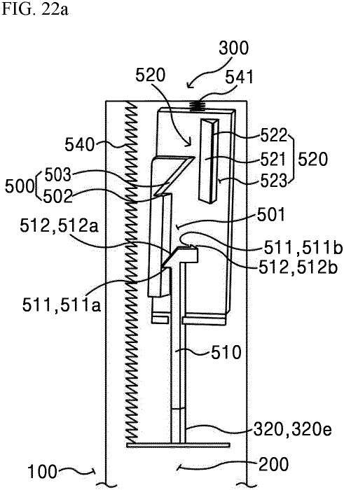

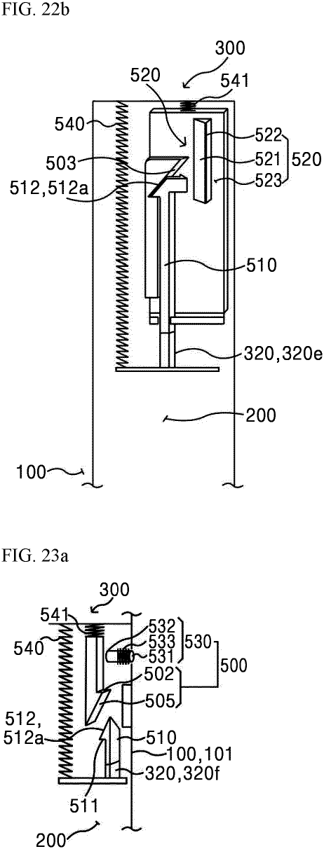

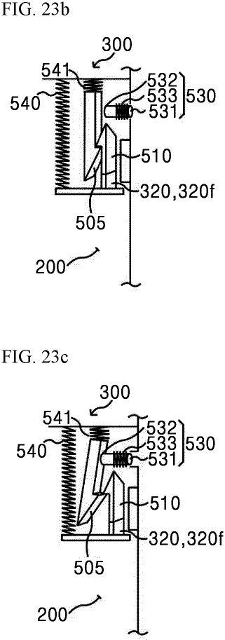

FIG. 22 is an enlarged schematic diagram for depicting the inside of the earphone storage unit according to another embodiment of the present invention. Referring to FIG. 22, the hanging portion 510 and the locking fixing portion 500 are formed on the contrary to FIG. 19. That is, the hanging portion 510 is integrally formed on the shaft 320 or 320e. Further detailed description will be omitted since being the same as the description of FIGS. 19 to 21 (namely, detailed description is omitted to avoid repetition of description.)

FIG. 23 is an enlarged schematic diagram for depicting the inside of an earphone withdrawing unit according to another embodiment of the present invention. Referring to FIG. 23, unlike FIG. 16, a locking release portion 530 is formed on the earphone withdrawing unit 300. A locking fixing portion 500 includes: a locking fixing protrusion 502 caught to a hook 511 of the hanging portion 510 to be fixed; and a locking release portion 530 for separating the hook 511 of the hanging portion 510 from the locking fixing protrusion 502.

In addition, the locking fixing portion 500 further includes a locking slope 505 formed on the locking fixing protrusion 502 to guide the hook 511 of the hanging portion to be introduced into the locking fixing protrusion 502.

Furthermore, the hanging portion 510 has the hook 511 formed at an end thereof, and further includes a first corresponding slope 512a formed on the hook to correspond to the locking slope 505.

In the present invention, the locking release portion 530 includes: a pressing portion 531; a touch portion 532; and an elastic member 533.

Referring to FIG. 23, fixing and releasing principles of the locking fixing portion of the earphone withdrawing unit 300 will be described in more detail. As illustrated in FIG. 23A, in a state in which the shaft 320 or 320f is pushed out before the earphone 400 is stored, when the user inserts the earphone in the earphone storage unit 200 and presses the earphone to a predetermined distance, the shaft 320 or 320f is pushed in, and the hook 511 of the hanging portion 510 is caught to the locking fixing protrusion 502 as illustrated in FIG. 23B.

In this instance, in order to lock or release the hook 511 of the hanging portion 510 to or from the locking fixing protrusion 502, the locking fixing protrusion 502 is lopsided by the elastic member 541 formed on the locking fixing protrusion 502, and the hook 511 is introduced into the locking fixing protrusion 502.

In the state of FIG. 23B, the earphone is stored in the earphone storage unit 200. In order to withdraw the earphone, when the user presses the pressing portion 531 of the locking release portion 530, the locking release portion 530 is inserted, and the touch portion 532 pushes the locking fixing protrusion 502. Accordingly, as illustrated in FIG. 23C, the locking fixing protrusion 502 is separated from the hook 511 of the hanging portion, and the hook 511 is pushed out. Thereafter, in the state of FIG. 23A, the earphone is withdrawn from the earphone storage unit by power that the shaft is pushed out.

Although the earphone withdrawing unit of the smartphone having the earphone storage part according to the present invention has been described above, the present invention is not limited thereto and may be modified and changed into various forms. All devices of the push-on/push-off operation method for withdrawing the earphone 400 from the cylindrical earphone storage unit 200 may correspond to the earphone withdrawing unit of the present invention.

In the present invention, the term ‘smartphone’ refers to all portable terminals, such as a flat portable terminal, a foldable portable terminal which is folded horizontally or vertically.

In the present invention, preferably, the earphone is stored in the earphone storage unit in a horizontal state when being stored in the earphone storage unit, and is vertically folded to be used after being withdrawn from the earphone storage unit when being used. However, according to circumstances, the earphone may be manufactured in a small size to be conveniently stored or used.

The embodiments of the present invention described above are combinations of elements and features of the present invention. The elements or features may be considered selective unless otherwise mentioned.

Each element or feature may be practiced without being combined with other elements or features. Furthermore, an embodiment of the present invention may be constructed by combining parts of the elements or features.

In a case in which two or more codes are written to each component, it may mean all of the two or more codes or any one of the two or more codes.

Operation orders described in embodiments of the present invention may be rearranged. Some constructions or features of any one embodiment may be included in another embodiment and may be replaced with corresponding constructions or features of another embodiment.

In addition, claims that are not explicitly cited in each other in the appended claims may be presented in combination as an embodiment of the present invention or included as a new claim by subsequent amendment after the application is filed.

The embodiments according to the present invention may be implemented by various means, for example, hardware, firmware, software, or a combination thereof.

The present invention may be carried out in other specific ways than those set forth herein without departing from the spirit and essential characteristics of the present invention. Therefore, the above embodiments should be construed in all aspects as illustrative and not restrictive.

The scope of the invention should be determined by the appended claims and their legal equivalents, and all changes coming within the meaning and equivalency range of the appended claims are intended to be embraced therein.

The embodiments of the present invention are disclosed for illustrative purposes, and those skilled in the art will appreciate that various modifications, changes, and additions are possible within the spirit and scope of the present invention, and such modifications, changes, and additions are intended to fall within the claims.

### Explanation of Reference Numerals

100: smartphone body 110: smartphone body battery
200: earphone storage unit 200a: first earphone storage unit
200b: second earphone storage unit 220: storage unit inlet
223: depth end portion 230: earphone charging terminal
240,240a: magnet or magnetic material
300: earphone withdrawing unit
300a: first earphone withdrawing unit 300b: second earphone withdrawing unit
310: cylinder 310a: cylinder, first cylinder
310b: cylinder, second cylinder 310c: cylinder, third cylinder
311: guide groove 311a: first guide groove
311b: second guide groove 312: guide protrusion
313: rotational slope 314: locking protrusion
320: shaft 320a: shaft, first shaft
320b: shaft, second shaft 320c: shaft, third shaft
320d: shaft, fourth shaft 320e: shaft, fifth shaft
320f: shaft, sixth shaft 321: moving protrusion
322: saw-teeth 330: knock member
331: knock protrusion 332: slope
333: groove 334: elastic member insertion protrusion
340: knock member support 340a: rear of knock member support
340b: side of knock member support 341: support surface
342: upper protrusion 343: lower protrusion
344: elastic member locking portion 344a: extension portion
344b: elastic member locking portion 345: elastic member
360: locking fixing portion 360a: end portion
360-1: frame 360-2: lower portion of locking fixing portion
362: hook moving path 362a: first hook moving path
362b: second hook moving path 362c: third hook moving path
362d: fourth hook moving path 362e: locking portion, first locking portion
362f: locking portion, second locking portion 362g: vertex
362h: one path through which hook moves, deeper part 362i: the other path, lower part
362j: movement guide protrusion 362p: fifth hook moving path
362q: sixth hook moving path 362r: seventh hook moving path
362s: locking portion, third locking portion 362u: locking portion, fourth locking portion
362t: slope A: first slope
B: second slope C: third slope
D: fourth slope E: fifth slope
F: sixth slope 362-1: first hook guide groove
362-2: second hook guide groove 363: hanging portion
363a: hook 363b: one end
363c: upper end of hook 363d: lower end of hook
364: elastic member 365: rotation prevention groove
365a: rotation prevention protrusion 366: hanging portion fixture
366a: hanging portion fixing ring 367: elastic member fixing portion
368: device moving portion 368a: extension portion
368b: earphone support 370: rotational movement path
370a: first rotational movement path 370b: second rotational movement path
370c: third rotational movement path 370d: fourth rotational movement path
370e: fifth rotational movement path 370f: sixth rotational movement path
371: rotation locking portion 372: rotational movement guide protrusion
373a, b,c,d,e: meeting point 374: one path, deeper part
375: the other path, shallow part 376: rotational movement protrusion
377: protrusion adjusting portion 378: shaft support
380: housing
400: earphone 400a: first body
400b: second body 400s: earphone insertion direction
500: locking fixing portion
501: straight movement path 502: locking fixing protrusion
503: separation slope 504: locking separation protrusion
505: locking slope 505a: locking slope end
506: locking separation path
510: hanging portion 510a: side of hanging portion
511: hook 511a: first hook
511b: second hook 512: corresponding slope
512a: first corresponding slope 512b: second corresponding slope
512c: third corresponding slope 512d: fourth corresponding slope
520: hook separation guide portion 521: guide slope
522: guide locking protrusion 523: guide movement path
530: locking release portion 531: pressing portion
532: touch portion 533: elastic member
54032: elastic member 5: elastic member

1. A smartphone having an earphone storage unit comprising:
at least one an earphone storage unit formed in a cylindrical shape; and
an earphone withdrawing unit for facilitating the withdrawal of an earphone stored in the earphone storage unit,
wherein the earphone withdrawing unit comprises:
a cylinder;
a shaft reciprocating in the cylinder;
a knock member rotating in response to the shaft whenever the shaft is pressed; and
an elastic member pushing the knock member outward in response to the knock member.

2. The smartphone according to claim 1, wherein the cylinder has guide grooves and guide protrusions formed inside the cylinder in a longitudinal direction, and
wherein the shaft has a moving protrusion moving along the guide groove in response to the guide groove.

3. The smartphone according to claim 1, wherein the knock member has a knock protrusion moving along the guide groove in response to the guide groove, and the knock member rotates at a predetermined angle whenever the shaft reciprocates once.

4. A smartphone having an earphone storage unit comprising:
at least one an earphone storage unit formed in a cylindrical shape; and
an earphone withdrawing unit for facilitating the withdrawal of an earphone stored in the earphone storage unit,
wherein the earphone withdrawing unit comprises:
a shaft reciprocating when the earphone is withdrawn from the earphone withdrawing unit; and
a locking fixing portion for making the shaft locked and fixed by a hook while the shaft performs a reciprocating motion.

5. The smartphone according to claim 4, wherein the locking fixing portion comprises:
a hook moving path through which the hook of a hanging portion moves; and
a locking portion for locking the locking fixing portion while the hook of the hanging portion moves along the hook moving path.

6. The smartphone according to claim 5, wherein the locking fixing portion further comprises:
a first slope, a second slope, a third slope, a fourth slope, and a fifth slope for guiding the hook to move along the plurality of hook moving paths.

7. The smartphone according to claim 6, wherein the locking fixing portion further comprises:
a first hook guide groove for guiding the hook to a second hook moving path; and
a second hook guide groove for guiding the hook to a fourth hook moving path.

8. The smartphone according to claim 5, wherein the hook moving path comprises:
a first hook moving path through which the hook of the hanging portion moves;
a second hook moving path extended and connected to the first hook moving path;
a third hook moving path extended and connected to the second hook moving path;
a fourth hook moving path extended and connected to the third hook moving path; and
a locking portion formed between the second hook moving path and the third hook moving path, or comprises:
a fifth hook moving path through which the hook of the hanging portion moves;
a sixth hook moving path extended and connected to the fifth hook moving path;
a seventh hook moving path extended and connected to the sixth hook moving path; and
a locking portion formed between the fifth hook moving path and the sixth hook moving path.

9. The smartphone according to claim 4, wherein the locking fixing portion comprises:
a cylinder; and
a rotational movement path which is formed in the cylinder and through which the hook of the shaft moves, and
wherein the shaft performs a reciprocating motion while rotating in the cylinder, and has a hook moving through the rotational movement path.

10. The smartphone according to claim 4, further comprising:
a hanging portion (510) formed integrally with the shaft or formed separately from the shaft to fix the shaft by locking the locking fixing portion (500).

11. The smartphone according to claim 10, wherein the locking fixing portion comprises:
a locking fixing protrusion caught to the hook of the hanging portion to be fixed in a state in which the shaft is inserted; and
a separation slope moving to separate the hook of the hanging portion from the locking fixing protrusion.

12. The smartphone according to claim 11, wherein the locking fixing portion further comprises:
a locking slope formed on the locking fixing protrusion to guide the hook of the hanging portion to be introduced into the locking fixing protrusion.

13. The smartphone according to claim 11, wherein the earphone withdrawing unit further comprises:
a hook separation guide portion for holding the hook when the hook of the hanging portion moves along the separation slope to be separated from the locking fixing protrusion and moves to a guide slope.

14. The smartphone according to claim 13, wherein the hook separation guide portion comprises:
a guide slope for guiding the second hook to be easily introduced into the hook separation guide portion;
a guide locking protrusion for locking the second hook of the hanging portion; and
a guide movement path for guiding movement of the second hook which is introduced into the hook separation guide portion.

15. The smartphone according to claim 10, wherein the locking fixing portion further comprises:
a locking fixing protrusion caught to the hook of the hanging portion to be fixed in a state in which the shaft is inserted; and
a locking release portion for separating the hook of the hanging portion from the locking fixing protrusion.
